(19) United States
(12) Patent Application Publication
(10) Pub. No.: US 2008/0246879 A1
(43) Pub. Date: Oct. 9, 2008

(54) Image processing apparatus

(75) Inventor: Kazuteru Adachi, Osaka (JP)

Correspondence Address: MORGAN LEWIS & BOCKIUS LLP, 1111 PENNSYLVANIA AVENUE NW, WASHINGTON, DC, 20004, US

(73) Assignee: Funal Electric Co., Ltd.

(21) Appl. No.: 12/155,364

(22) Filed: Jun. 3, 2008

(30) Foreign Application Priority Data
Apr. 6, 2007 (JP) 2007-147824

(51) Int. Cl. H04N 5/44

(52) U.S. Cl. 348/553; 348/E05.096

(57) ABSTRACT

An image processing apparatus includes a device detecting portion which performs detection of device portions which are connected to a communication bus; a storing portion which stores kind information which shows kind of all the device portions that can be connected to the communication bus and general-purpose control program which can control all the device portions that can be connected to the communication bus; and a control portion which reads out the general-purpose control program from the storing portion to execute when control of the respective device portions which are provided in a group of devices is performed. The control portion discriminates between kind of the device portions which are connected to the communication bus and kind of the device portions which are not connected to the communication bus utilizing the detection result and the kind information. When the general-purpose control program is executed, a part of the program which relates to the device portions which are not connected to the communication bus is skipped and control of the device portions is not performed.

This application is based on Japanese Patent Application No. 2007-147824 filed on Jun. 4, 2007, and the contents of which are hereby incorporated by reference.

### BACKGROUND OF THE INVENTION

1. Field of the Invention

The present invention relates to an image processing apparatus, especially, the present invention relates to an image processing apparatus which has an object to improve general versatility of software ROM in which software to perform control of the image processing apparatus is stored.

2. Description of Related Art

Recently, as the image processing apparatus becomes to have multifunction, an image processing apparatus on which device portions to connect various external devices are loaded, has been widely popularized. To be more concrete, there are the device portions, for example, an external connection terminals such as a component terminal, an S terminal, an RGB terminal, an HDMI terminal and an I-Link terminal, a video decoder to connect an analog tuner, an OFDM demodulation circuit to connect an digital tuner, and the like.

However, different kinds of device portions as above described are loaded on an image processing apparatus depending on kind of the image processing apparatus. For example, input data cannot be processed in an image processing apparatus using analog method such as analog video apparatus, even though an HDMI terminal of digital method or the like is included. Therefore, the external connecting terminal of the digital method is not typically included.

As above described, because an internal configuration of the device is different depending on performance or kind of the image processing apparatus, there is necessity to make ROM on which software to perform control of these device portions is stored (hereinafter, referred to as “software ROM”) for every kind of the device. However, many operations are required to make the software ROM such as for performance check, preparation of a mask ROM, and the like. As a result, there is a problem that efficiency becomes very bad to create the software ROMs for every kind of the device for a plurality of kinds of devices in which there is little difference in the device configuration.

With regard to the above described problem, in JP-A-2001-312455, a device control unit is disclosed which can control activities of a plurality of kinds of devices based on a driver software that is a control program without exchanging the ROM which is loaded on the CPU board to control activity of the devices.

In the device control unit disclosed in JP-A-2001-312455, a plurality of control programs are stored to activate a plurality of kinds of devices respectively, a control program to activate a prescribed device is selected from the plurality of stored control programs based on a setting data from an upper control unit and it is activated. According to this arrangement, even when kinds of the devices are different, it is possible to control the devices by single kind of CPU board on which a ROM of a same content is loaded.

Further with regard to the above described problem, in JP-A-2005-309912 an image forming apparatus is disclosed which has an object to reduce time for activating the image forming apparatus and to effectively utilize a working area in which an image processing program is stored in case where all the plurality of stored image processing programs are stored in a RAM.

The image forming apparatus disclosed in JP-A-2005-309912 discriminates kind of image information based on the image information which is input from an upper unit, an image processing program that applies to the discriminated kind of the image information is selected from a plurality of image processing programs which are in advance stored in a memory portion and it is loaded to activate. According to this arrangement, a process to judge if the plurality of image processing programs apply to in a prescribed order, becomes unnecessary.

However, the program is changed to utilize corresponding to a device configuration and content of the process in JP-A-2001-312455 or JP-A-2005-309912. Therefore, it is necessary to store all control programs which are required to all the device configurations and all the content of process that can be conceivable. However, there is a limit of number of control programs which can be stored because the software ROM has typically small recording capacity due to problems of cost and the like.

### SUMMARY OF THE INVENTION

The present invention is made in view of the above described problem and it is an object of the present invention to provide an image processing apparatus which production of a plurality kinds of the apparatuses is assumed to have a different part in device configuration, which is not necessary in advance to prepare and to store a plurality of control programs corresponding to each of the kinds and which makes it possible to make production cost of the software ROM lower than a conventional image processing apparatus.

To attain the above described object an image processing apparatus in accordance with the present invention includes: a control portion; a storing portion; a plurality of device portions which can be controlled by the control portion; a communication bus which connects the control portion and the device portions; and a device detecting portion which performs detection of the device portions which are connected to the communication bus, and the apparatus is characterized in that the storing portion stores kind information which shows kind of all the device portions that can be connected to the communication bus, and general-purpose control program which is utilized by the control portion to perform control of the device portions, when the general-purpose control program is executed by the control portion, detection is performed by the device detecting portion, discrimination is performed between the kind of the device portions which are connected to the communication bus and the kind of the device portions which are not connected to the communication bus based on the detection result and the kind information, and the general-purpose control program is executed such that the device portions which are not connected to the communication bus are not an object to be controlled.

According to this arrangement, the image processing apparatus in accordance with the present invention includes a control portion; a storing portion which is composed of recording media such as memory, ROM, and the like; a group of devices which are composed of a plurality of device portions that can be controlled by the control portion; a communication bus which connects the control portions and the device portions. The information processing apparatus further includes a device detecting portion which performs detection of the device portions which are connected to the communication bus. In addition, kind information which shows kind of all the device portions which can be connected to the communication bus and a general-purpose control program which can control all the device portions that can be connected to the communication bus, are stored in the storing portion.

When the control portion performs control of the respective device portions which are included in the group of devices, the control portion reads out the general-purpose control program from the storing portion and executes it. Detection of the device portions which are connected to the communication bus is performed by the device detecting portion at that time. The control portion discriminates between kind of the device portions which are connected to the communication bus and kind of the device portions which are not connected utilizing the detection result and the kind information. When the general-purpose control program is executed, a part of the program which relates to the device portions which are not connected to the communication bus is skipped and control of the device portions is not performed. If specific device portion is not loaded, occurrence of program execution error can be prevented according to this arrangement. As a result, it becomes possible to control the group of devices only by single general-purpose control program regardless of device configuration of the image processing apparatus.

Further, to attain the above described object, the image processing apparatus in accordance with the present invention further includes: a discriminating information obtaining portion which stores discriminating information that shows result of the discrimination in the storing portion when power of the image processing apparatus is turned on in the image processing apparatus structured as above described. And the apparatus is characterized in that when the general-purpose control program is executed by the control portion, the discriminating information is read out from the storing portion, then the execution of the general-purpose control program is performed.

According to this arrangement, the image processing apparatus in accordance with the present invention further includes at-start discriminating portion (discriminating information obtaining portion) which stores the discriminating information that shows the result of discrimination in the storing portion when power of the image processing apparatus is turned on. Then, a part of the program which relates to the device portions which are not connected to the communication bus is skipped and control of the device portions is not performed based on the discriminating information when the control portion executes the general-purpose control program. According to this arrangement, it is possible to prevent occurrence of program execution error when a specific device portion is not loaded. As a result, it becomes possible to control the group of devices only by single general-purpose control program regardless of device configuration of the image processing apparatus.

Still further, to attain the above described object, the image processing apparatus in accordance with the present invention is characterized in that the storing portion stores first related information which correlates an address of a connecting portion that connects the communication bus and the device portions with the kinds of the device portions that are connected corresponding to the address, the device detecting portion sends a prescribed signal to the connecting portion, and the detection of the device portions which are connected to the communication bus is performed based on the address of the connecting portion from which reply is returned and the first related information.

According to this arrangement, individual address is assigned to the connecting portion which is a connecting point between the communication bus and the device portions in the image processing apparatus in accordance with the present invention. Then address information (the first related information) which is information that shows which device portion is connected at a connecting portion of each address, is stored in the storing portion. When the device detecting portion performs detection of the device portions, the device detecting portion sends a prescribed signal to all the connecting portions which are included in the communication bus. To the signal a normal reply is returned from the connecting portion to which the device portion is connected. By this reply, kinds of the device portions which are connected to the communication bus can be identified from the address of the connecting portion from which the normal reply is returned and the address information.

Still further, to attain the above described object the image processing apparatus in accordance with the present invention is characterized in that the storing portion stores second related information which correlates a device ID of a connecting slot that connects the communication bus and the device portions with the kinds of the device portions that are connected corresponding to the device ID, the device detecting portion sends a prescribed signal to the connecting slot, and the detection of the device portions which are connected to communication bus is performed based on the device ID of the connecting slot from which reply is returned and the second related information.

According to this arrangement, an individual device ID is assigned to the connecting slot which is a connecting point between the communication bus and the device portions in the image processing apparatus in accordance with the present invention. Then, device ID information (the second related information) which is information that shows which device portion is connected at a connecting slot of each device ID, is stored in the storing portion. When the device detecting portion performs detection of the device portions, the device detecting portion sends a prescribed signal to all the connecting slots which are included in the communication bus. To the signal, a normal reply is returned from the connecting slot to which the device portion is connected. By this reply, kinds of the device portions which are connected to the communication bus can be identified by the device ID of the connecting slot from which the normal reply is returned and the device ID information.

Still further, to attain the above described object the image processing apparatus in accordance with the present invention is characterized in that detecting object of the device detecting portion is an external connecting terminal to perform input and output of video signal and audio signal.

According to this arrangement, detection object of the device detecting portion is an external connecting terminal to perform input and output of video signal and audio signal, for example, a component terminal or the like in the image processing apparatus in accordance with the present invention. As a result, it is possible to control the external connecting terminal by only one single general-purpose control program regardless of configuration of the external connecting terminal which tends to be comparatively different in configuration for every kind of the image processing apparatus.

Still further, to attain the above described object the image processing apparatus in accordance with the present invention is characterized in that detecting object of the device detecting portion is a demodulator to perform demodulation of video signal and audio signal which are input from a tuner.

According to this arrangement, detection object of the device detecting portion is a demodulator performing demodulation of video signal and audio signal which are input from the tuner, for example, an analog decoder or the like in the image processing apparatus in accordance with the present invention. As a result, it is possible to control the demodulator by only one single general-purpose control program regardless of configuration of the demodulator which tends to be comparatively different in configuration for every kind of the image processing apparatus.

In accordance with the present invention described above, it is not necessary to prepare the control programs for every kind of the image processing apparatus, and it is possible to reduce activity checking of the control program and to reduce production cost for the software ROM in which the control program is stored. Further, compared to a case where a plurality of control programs are utilized for every kind, memory resource can be effectively utilized because recording capacity in the used software ROM is small.

Further, term till shipping can be shortened when new kind of the apparatus is developed because there is no need to create new software ROM. In addition, efficiency of the processing can be improved because it is not necessary to perform-detection of the device portions for every execution of the general-purpose control program. Still further, it is possible to identify the kinds of the device portions which are connected to the communication bus even in case where technical standard of the image processing apparatus does not define which device portion is connected to each connecting portion.

More further, it is possible to identify the kinds of the device portions which are connected to the communication bus even in case where technical standard of the image processing apparatus does not define which device portion is connected to each connecting slot. In addition, processing speed of the detection process can be improved because detecting object are only the external connecting terminal and the demodulator which comparatively tend to be different in configuration according to kind of the image processing apparatus but device portions having little difference in the device configuration according to kind of the image processing apparatus are no detection object.

### BRIEF DESCRIPTION OF THE DRAWINGS

FIG. 1 is a functional block diagram to show structure of a function portion which is included in an image processing apparatus according to a first embodiment of the present invention;

FIG. 2 is a block diagram to show inner structure of the image processing apparatus according to the first embodiment of the present invention;

FIG. 3 is a block diagram to show structure of a communication bus according to the first embodiment of the present invention;

FIG. 4 is a process flow chart to show an execution process of a general-purpose control program according to the first embodiment of the present invention;

FIG. 5 is a block diagram to show state transition of the image processing apparatus according to the first embodiment of the present invention;

FIG. 6 is a functional block diagram to show structure of a function portion which is included in an image processing apparatus according to a second embodiment of the present invention;

FIG. 7 is a process flow chart to show a device detecting process when the apparatus is turned on according to the second embodiment of the present invention;

FIG. 8 is a process flow chart to show an execution process of a general-purpose control program according to the second embodiment of the present invention; and

FIG. 9 is a block diagram to show a part of structure of a communication bus according to a third embodiment of the present invention.

### DESCRIPTION OF THE PREFERRED EMBODIMENTS

Hereinafter embodiments of the present invention will be described with reference to drawings. It should be noted that the embodiments shown here are mere examples and the present invention is not limited to the embodiments shown here.

### Embodiment 1

### 1-1. About Inner Structure

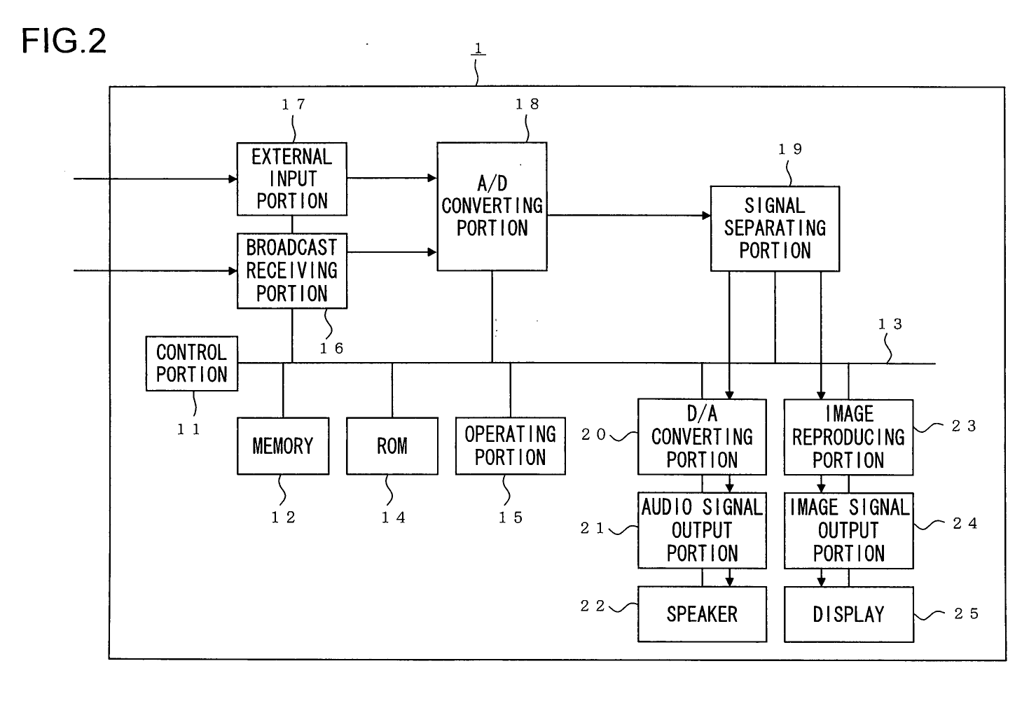

FIG. 2 is a block diagram to show a television apparatus 1 according to a first embodiment of the present invention. It should be noted that a line with an arrow head in FIG. 2 shows a flow of data. A line without the arrow head shows a communication bus through which a control portion 11 sends and receives a control signal and the like for each of device portions. The television apparatus 1 is structured such that it includes at least the control portion 11, a memory 12, a communication bus 13, a ROM 14 (storing portion), an operating portion 15, a broadcast receiving portion 16 (demodulator), an external input portion 17 (external connecting terminal), an A/D converting portion 18, a signal separating portion 19, a D/A converting portion 20, an audio signal output portion 21, a speaker 22, an image reproducing portion 23, an image signal output portion 24, and a display 25.

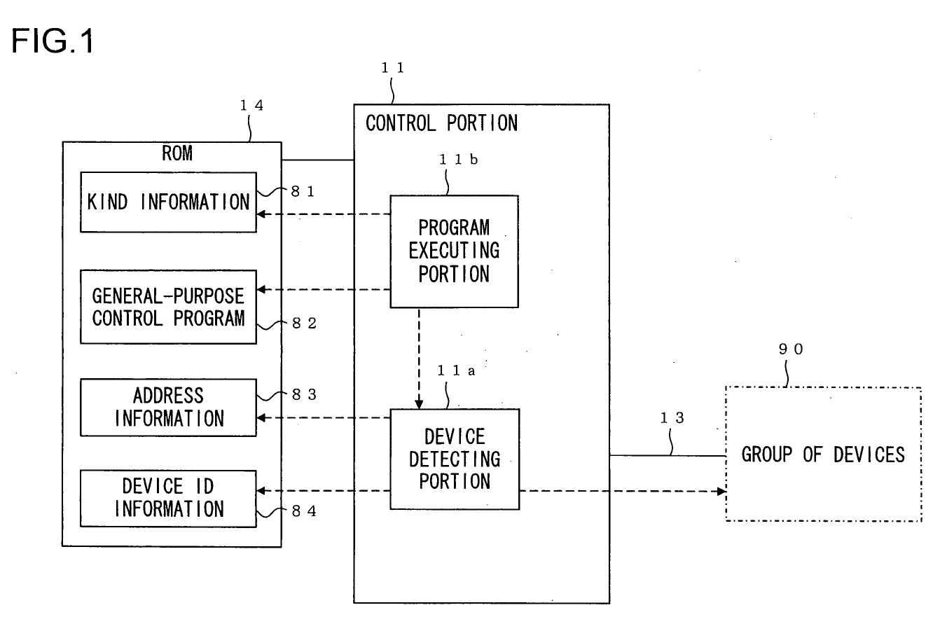

The control portion 11 is made to control image information processing, for example, receiving television program, display processing of received television program, and the like by controlling driving of the respective device portions of the television apparatus 1, and the control portion 11 is composed of, for example, a plurality of microprocessors. Further, the control portion 11 is a central brain to perform control of the respective device portions, calculation and processing of data, and the like. It should be noted that the control portion 11 includes a plurality of function portions, for example, a device detecting portion 11a which is shown in FIG. 1 and the like, and the function portions are realized by executing program. Detail of the respective function portions will be described later.

The memory 12 is a recording medium to store temporarily various kinds of data which is kept by the television apparatus 1, and it is composed of, for example, a writable random access memory (RAM) and the like. The memory 12 has a role as a buffer memory for temporarily storing processing data when various kinds of information processing is performed by the control portion 11, direction command received from a user, and the like.

The communication bus 13 is a transmission path to connect the control portion 11 and the respective device portions and to perform transmission of various kinds of control signals. To be more concrete, as the communication bus 13, transmission path in the inter-integrated circuit (I2C) standard, the peripheral component interconnect (PCI) standard, and the like, are utilized.

The ROM 14 is a recording medium to store control program which is used by the control portion 11 to perform control of the respective device portions, various kinds of setting parameters which is defined when the television apparatus 1 is shipped from factory, and the like. Only reading-out is possible from ROM 14, but recording or rewriting is impossible.

The operating portion 15 is made to give various commands to the television apparatus 1 for user to perform viewing, hearing, and the like of program. The command which is output by the operating portion 15 is received by the control portion 11. The control portion 11 which receives the command, performs channel selecting process, volume control process and the like based on content of the command.

The broadcast receiving portion 16 is connected to an external antenna (not shown) and performs channel selecting, receiving, frequency conversion, amplifying, demodulation, and the like of digital broadcast or analog broadcast. According to this arrangement, video signal, audio signal, and the like are obtained from the received broadcast signal. The broadcast receiving portion 16 is structured such that it includes an analog tuner, a video intermediate frequency amplifier circuit, a demodulation circuit, an amplifier circuit, and the like when it is for analog method. The broadcast receiving portion 16 is structured such that it includes a digital tuner, an error correction portion, a multi-separating portion, and the like when it is for digital method.

The external input portion 17 includes a plurality of external connecting terminals such as, for example, an RCA input terminal to which composite signal is input, an S terminal to which S signal is input, and the like. The external input portion 17 connects the television apparatus 1 to external recorded image processing apparatus, such as, for example, a DVD player, an HDD recorder, and the like to input the video signal and the audio signal utilizing the above external connecting terminals.

The analog/digital (A/D) converting portion 18 converts an input signal into the digital signal if the input signal input from the broadcast receiving portion 16 and the external input portion 17 is an analog signal such as a composite signal or the like. It should be noted that the A/D converting portion 18 does not convert the signal and outputs the input signal directly to the signal separating portion 19 in next stage, if the input signal is a digital signal.

The signal separating portion 19 separates the input digital signal into a digital signal including audio information and a digital signal including video information if the input digital signal which is input from the A/D converting portion 18, is encoded by MPEG2 method or the like. Among the digital signals, the digital signal including the audio information is sent to the D/A converting portion 20 to be converted into an analog signal, and it is output from the speaker 22 by the audio signal output portion 21. It should be noted that the audio signal output portion 21 performs adjustment of volume of the output sound and the like based on the command received from the control portion 11 at this time.

The digital signal which includes the video information that is separated by the signal separating portion 19, is decoded by the image reproducing portion 23 and further, it is converted into the video signal in NTSC method. The video signal which is obtained by the conversion, is displayed on the display 25 by the image signal output portion 24. It should be noted that the image signal output portion 24 performs adjustment or the like of picture quality or brightness of output image based on the command received from the control portion 11 at this time.

### 1-2. About Maximum Configuration of the Device Portions

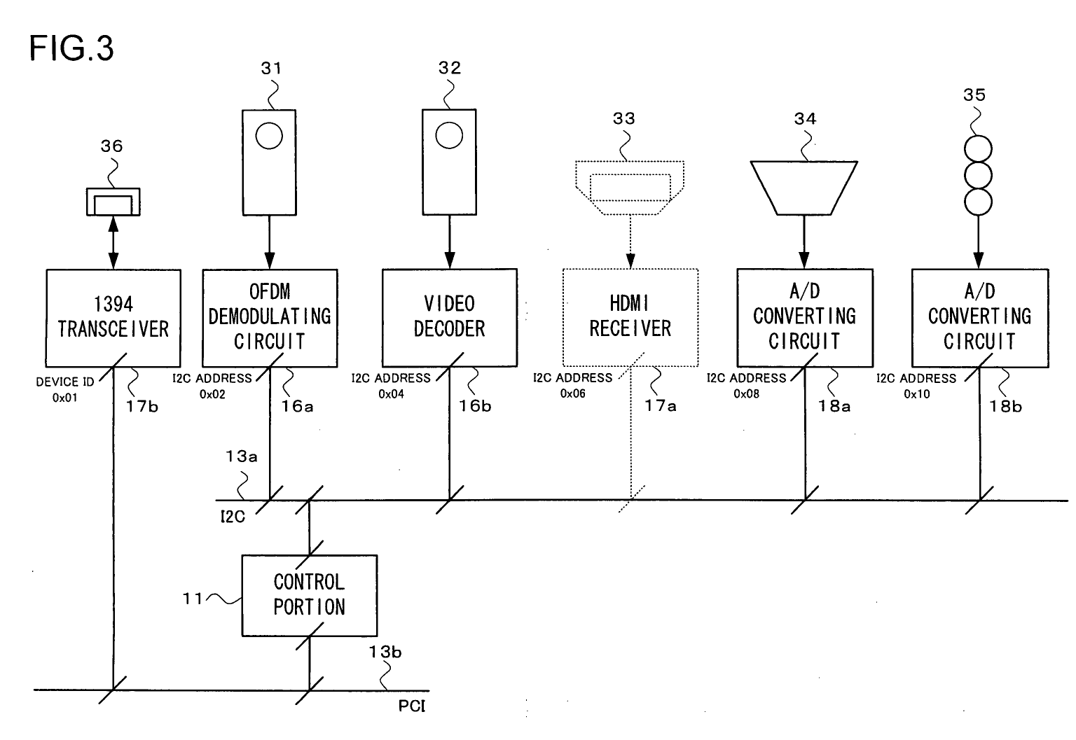

Hereinafter, an explanation will be given about maximum configuration of the device portions which can be connected to the communication bus 13 that is included in the television apparatus 1 according to the first embodiment of the present invention with reference to a block diagram in FIG. 3.

As shown in FIG. 3, the communication bus 13 in accordance with the present invention is structured such that it includes at least the I2C bus 13a and the PCI bus 13b. An OFDM demodulating circuit 16a and a video decoder 16b which are included in the broadcast receiving portion 16, an HDMI receiver 17a which is included in the external input portion 17, and A/D converting circuit 18a and A/D converting circuit 18b which are included in the A/D converting portion 18 can be connected to the I2C bus 13a. Further a 1394 transceiver 17b which is included in the external input portion 17 can be connected to the PCI bus 13b.

It should be noted that the I2C addresses shown in the drawing show addresses of the connecting portions to connect the respective device portions to the I2C bus 13a. Further, a device ID shown in the drawing shows the device ID of a PCI slot (connecting slot) at which the respective device portions are connected to the PCI bus 13b. Further, the device portion shown in dotted line (HDMI receiver 17a or the like) shows the device portion which is not connected in the present embodiment.

The OFDM demodulating circuit 16a is connected to the digital tuner 31 to perform demodulation of the digital broadcast signal which is input from the digital tuner 31. The video decoder 16b is connected to the analog tuner 32 to perform demodulation of the analog broadcast signal which is input from the analog tuner 32. The HDMI receiver 17a is connected to the HDMI terminal 33 to perform image conversion or noise correction process and the like of the digital signal which is input from the HDMI terminal 33.

The 1394 transceiver 17b is connected to the I-Link terminal 36 to perform sending or receiving of electric signal with an external device. The A/D converting circuit 18a and the A/D converting circuit 18b are connected to the RGB terminal 34 or the component terminal 35 to convert analog video signal which is input from each of the terminals into digital video signal.

### 1-3. About Structure of Function Portion

Hereinafter structure of the function portion which is included in the television apparatus 1 according to the first embodiment of the present invention will be explained with reference to function block diagram of FIG. 1.

As shown in FIG. 1 the television apparatus 1 in accordance with the present invention is structured such that it includes the device detecting portion 11a and a program executing portion 11b which are included in the control portion 11, the communication bus 13, kind information 81, a general-purpose control program 82, address information 83 (first related information), and device ID information 84 (second related information) which are stored in the ROM 14, and a group of devices 90.

The device detecting portion 11a is made to perform detection of the respective device portions which are connected to the communication bus 13. To be more concrete, the device detecting portion sends a detection signal to the respective connecting portions or connecting slots of the communication bus 13 shown in FIG. 2. When normal reply for the detection signal is returned, it is judged that a device portion is connected to the connecting portion or the connecting slot. It should be noted that it is discriminated what kind of the device portion is connected to the address or the device ID from which the normal reply is returned utilizing the address of the connecting portion or the device ID of the connecting slot from which the normal reply is returned, the address information 83 and the device ID information 84 that will be explained later at this time.

The program executing portion 11b is made to execute the general-purpose control program 82 that will be explained later. At this time, discrimination between the device portion which is connected to the communication bus 13 and the device portion which is not connected to the communication bus is performed utilizing the kind information 81 that will be explained later and detecting result of the device portion by the device detecting portion 11a. In case where a part of a program that relates to the device portion which is not connected, exists when the program is executed, execution of the part is skipped.

The kind information 81 is information which shows kind of all the device portions which can be connected to the communication bus 13. The general-purpose control program 82 is a control program which can control all the device portions that can be connected to the communication bus 13. The general-purpose control program 82 is composed of a combination of a plurality of control programs and it contains in itself information which device is an object to be controlled by each of the control programs. The program executing portion 11b makes a decision to perform or not a control for each control object unit by checking the information.

The address information 83 is information which correlates the I2C address of each of the connecting portions that is included in the communication bus 13 with the kind of the device portion that is connected corresponding to the I2C address. In an example shown in FIG. 3, it is decided in advance that the OFDM demodulating circuit 16a is connected to the connecting portion which has address 0x02 of the I2C address of the I2C bus 13a, and that the video decoder 16b is connected to the connecting portion which has address 0x04 of the I2C address of the I2C bus 13a, and they are stored in the address information 83.

The device ID information 84 is information which correlates the device ID of each of the connecting slots that is included in the communication bus 13 with the kind of the device portion that is connected corresponding to the device ID. In an example shown in FIG. 3, for example, it is decided in advance that the 1394 transceiver 17b is connected to the connecting slot which has address 0x01 of the device ID of the PCI bus 13b, and it is stored in the device ID information 84.

The group of devices 90 totally shows a plurality of device portions which are connected to the I2C bus 13a and the PCI bus 13b in FIG. 2, in fact, individual device portion is connected to the communication bus 13 through each of the connecting portions.

### 1-4. About Execution Process of General-purpose Control Program

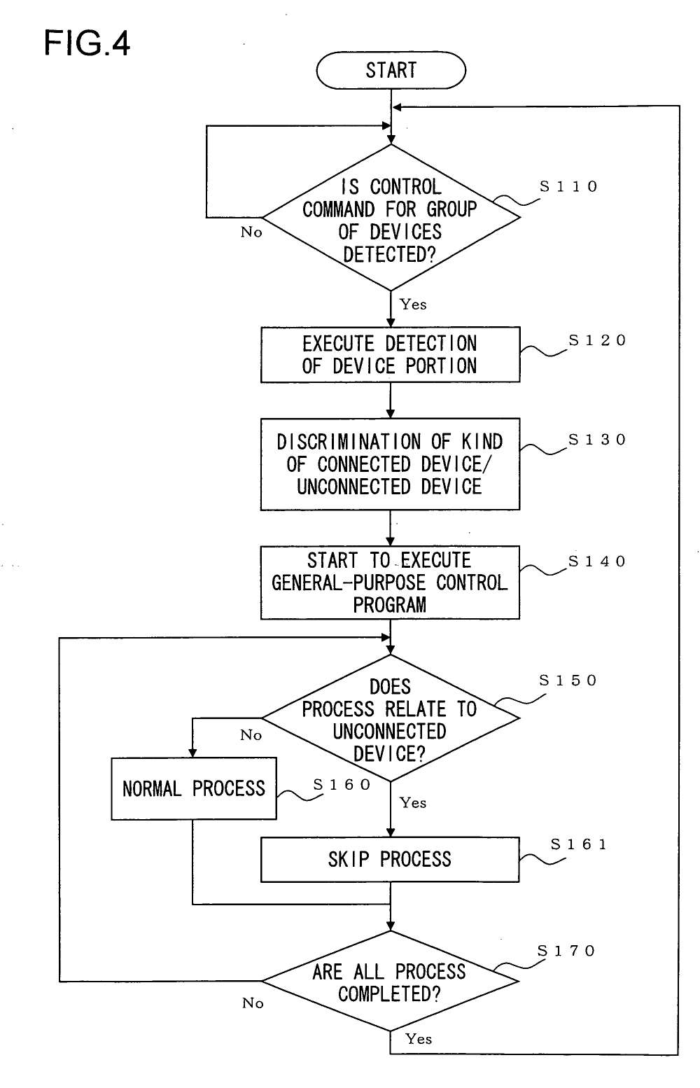

Hereinafter explanation will be given about execution process of the general-purpose control program 82 according to the first embodiment of the present invention with reference to the block diagrams of FIG. 1 to FIG. 3 and the flowchart of FIG. 4.

FIG. 4 is a flow chart to show a process flow when the general-purpose control program 82 according to the first embodiment of the present invention is executed. The power supply to the television apparatus 1 is detected by the control portion 11 to start the process shown in FIG. 4. It should be noted that direction of the power supply is output in case where a power-on button which is included in the operating portion 15 is pushed on, for example.

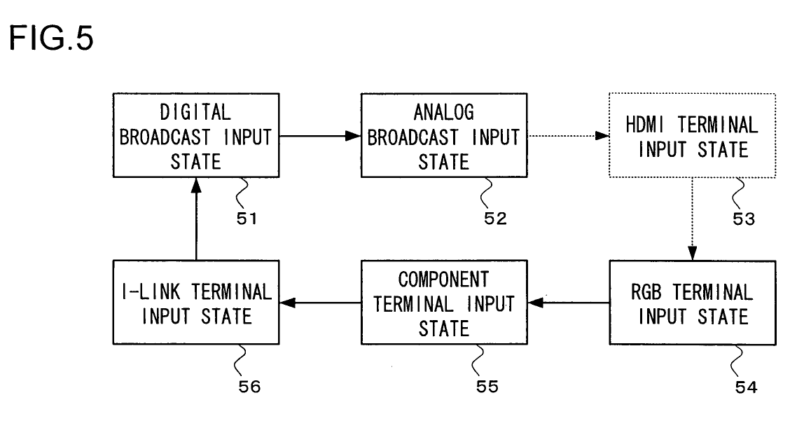

After this process is begun, in step S110, the control portion 11 performs judgment whether a process that requires control of an device portion which can be connected to the communication bus 13, is occurred. To be more concrete, as shown in FIG. 5, it corresponds to a switching process of input source of image and sound which are output from the speaker 22 and the display 25, for example.

FIG. 5 shows state transition of the television apparatus 1 in case where an input switching button (not shown) which is included in the operating portion 15 is pushed down by user. It should be noted that the state shown by dotted line shows a state that cannot be realized in the television apparatus 1 according to the present embodiment though the state can be realized in the television apparatus in the maximum configuration. This is because the HDMI terminal 33 and the HDMI receiver 17a are not loaded on the television apparatus 1 as shown in FIG. 3.

Assuming that a digital broadcast is input by the digital tuner 31 and the OFDM demodulating circuit 16a in FIG. 5, for example (digital broadcast input state 51). When the input switching button is pushed down once in this state, the state changes to an analog broadcast input state 52. According to this transition, input of an analog broadcast is performed by the analog tuner 32 and the video decoder 16b instead of the digital tuner 31 and the OFDM demodulating circuit 16a which are used as the input source.

In case where the process which requires control of the device portion that can be connected to the communication bus 13 as above described example, is not detected, the control portion 11 moves to step S110 again and continuously monitor until the above described process is detected. To the contrary, in case where occurrence of the above described process is detected, in step S120 the device detecting portion 11a performs detection of the device portion which is connected to the communication bus 13 utilizing the address information 83 and the device ID 84. Result of the detection is reported to the program executing portion 11b.

Next, in step S130 the program executing portion 11b discriminates kind of the device portion which is connected to the communication bus 13 (connected device) and the device portion which is not connected (unconnected device) utilizing the reported detection result and the kind information 81. In the configuration shown in FIG. 3, for example, the OFDM demodulating circuit 16a, the video decoder 16b, the A/D converting circuit 18a, the A/D converting circuit 18b, and the 1394 transceiver 17b are included in the detection result. According to this discrimination, it is discriminated that the HDMI receiver 17a which is not included in the detection result, is a device that is not connected to the communication bus.

Next, in step S140 the program executing portion 11b starts execution of the general-purpose control program 82 which is stored in the ROM 14. Then in step S150, the program executing portion 11b performs judgment whether the process to be executed in the general-purpose control program 82 is a process which relates to the unconnected device. For example, this judgment method is as follows: the general-purpose control program 82 is separated into a plurality of program modules in advance, and the object to be controlled which is set for every module is referred to by the program executing portion 11b. Otherwise a table in which a module name and kind of the device which is the object to be controlled in the module are correlated, may be stored in the ROM 14 in advance, and the table may be referred to.

In case where it is judged that the process is not a process which relates to the unconnected device in step S150, the program executing portion 11b executes a normal process, that is, the program module for the process in step S160. To the contrary, in case where it is judged that the process is a process which relates to the unconnected device, the program executing portion 11b judges that the unconnected device does not exist and the process is skipped in step S161.

Assuming that the control command which is detected in step S110 is a switching command to switch from the digital broadcast input state 51 to the analog broadcast input state 52 shown in FIG. 5, for example. In this case, because the devices which relate to the switching process, that is, the OFDM demodulating circuit 16a and the video decoder 16b, are both connected to the I2C bus 13a as shown in FIG. 3, this switching process is normally executed.

Further, assuming that the control command which is detected in step S110 is a switching command to switch from the analog broadcast input state 52 to the HDMI terminal input state 53 shown in FIG. 5, for example. In this case, only the video decoder 16b is connected to the I2C bus 13a between the devices which relate to the switching process, that is, the video decoder 16b and the HDMI receiver 17a as shown in FIG. 3. Therefore, the HDMI terminal input state 53 is skipped as the transition state, then transition to next RGB terminal input state 54 is performed.

Next, in step S170 the program executing portion 11b performs judgment whether execution of all the control programs that relate to the commanded control is completed or not. In case where it is not completed, the process returns to step S150. In case where it is completed, the process moves to step S110 again. It should be noted that this process is normally terminated when power of the television apparatus 1 is turned off.

### Second Embodiment

### 2-1. About Internal Configuration

Explanation will be omitted because it is quite the same as the first embodiment.

### 2-2. About Maximum Configuration of Device Portion

Explanation will be omitted because it is quite the same as the first embodiment.

### 2-3. About Configuration of Function Portion

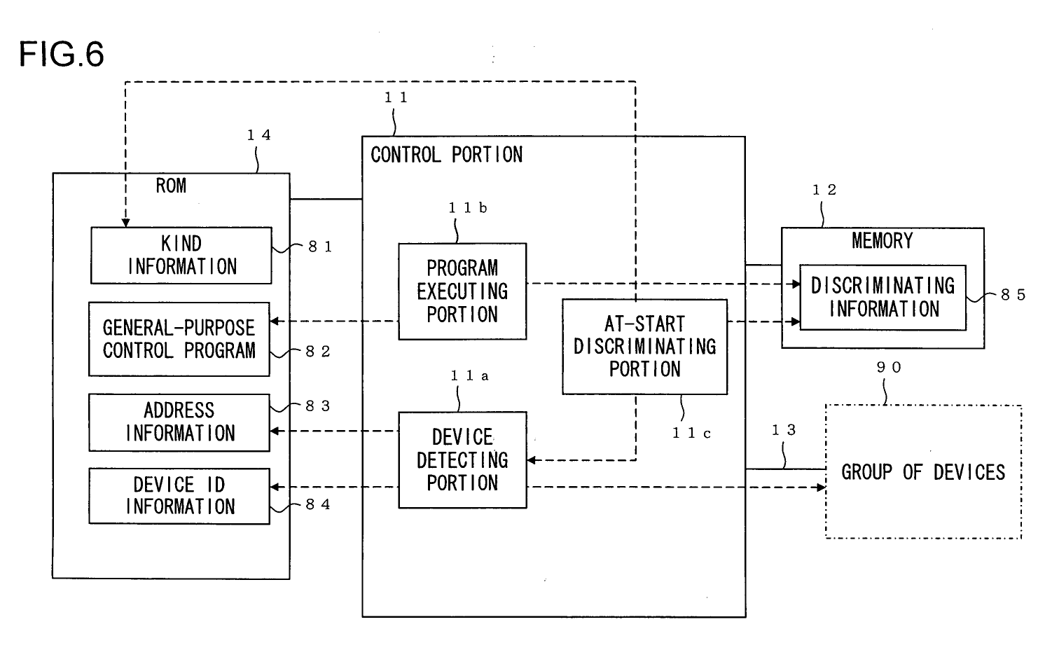

Hereinafter configuration of the function portion which is included in the television apparatus 1 according to a second embodiment of the present invention will be explained with reference to a functional block diagram of FIG. 6. It should be noted that the portions which are the same as those in the first embodiment are given the same reference numerals and further explanation about them will be omitted.

The differences from the first embodiment are: the control portion 11 includes an at-start discriminating portion 11c, the memory 12 stores discriminating information 85 as shown in FIG. 6.

The discrimination of kind of the device portion which is connected to the communication bus 13 and the device portion which is not connected to the communication bus is performed utilizing the device detecting portion 11a and the kind information 81 by the at-start discriminating portion 11c when power of the television apparatus 1 is turned on. Then result of the discrimination is stored in the memory 12 as the discriminating information 85. The stored discriminating information 85 is referred to when the general-purpose control program 82 is executed by the program executing portion 11b.

### 2-4. About Device Detecting Process When Power is Turned On

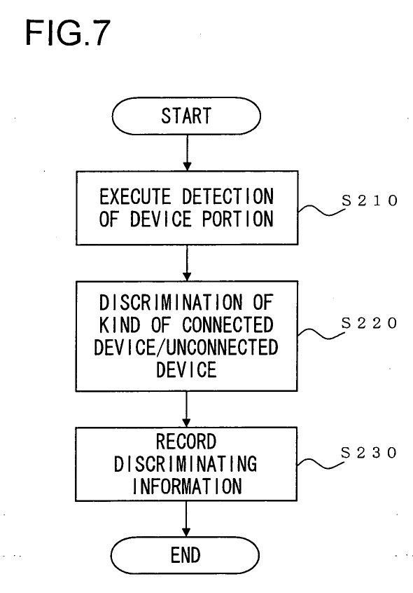

Hereinafter explanation will be given about the device detecting process which is executed when power of the television apparatus 1 according to the second embodiment of the present invention is turned on, with reference to the block diagram of FIG. 6 and a flow chart of FIG. 7.

FIG. 7 is a flowchart to show a detection process flow which is executed for the group of the devices 90 when power of the television apparatus 1 according to the second embodiment of the present invention is turned on. This process shown in FIG. 7 is started when power supply to the television apparatus 1 is detected by the control portion 11. It should be noted that direction of the power supply is output, for example in case where a power-on button which is included in the operating portion 15, for example, is pushed down.

After this process is started, in step S210, the at-start discriminating portion 11c commands the device detecting portion 11a to detect the devices which are included in the group of devices 90. The device detecting portion 11a receiving the command sends a prescribed signal to the communication bus 13. The device detecting portion 11 performs detection of the devices which are included in the group of devices 90 utilizing reply to the sent signal, the address information 83, and the device ID 84. Result of the detection is reported to the at-start discriminating portion 11c.

Next, in step S220, the at-start discriminating portion 11c discriminates the kind of the device portion which is connected to the communication bus 13 and the device portion which is not connected utilizing the reported detection result and the kind information 81. Then in step S230, the result of discrimination is stored in the memory 12 as the discriminating information 85, and the process is terminated.

### 2-5. About Execution Process of general-purpose Control Program

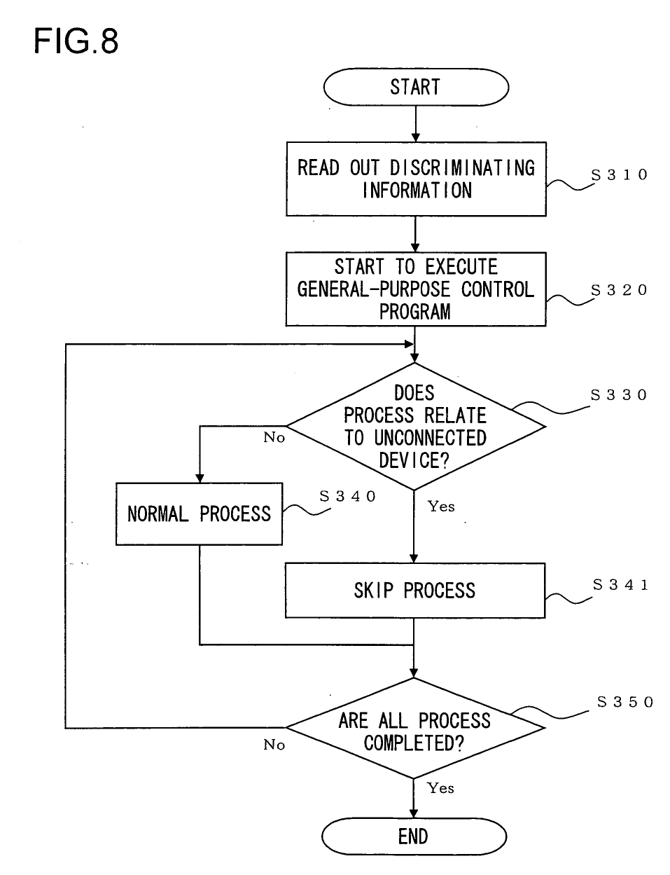

Hereinafter explanation will be given about the execution process of the general-purpose control program 82 according to the second embodiment of the present invention with reference to the block diagram of FIG. 6 and a flowchart of FIG. 8.

FIG. 8 is a flowchart to show a process flow when the general-purpose control program 82 according to the second embodiment of the present invention is performed. The process shown in FIG. 8 is started when a control command is output to the group of devices 90 which are included in the television apparatus 1. It should be noted that the control command is output in case where operation by user utilizing an operation button (not shown) which is included in the operating portion 15 or the like is detected, for example.

After this process is started, in step S310, the program executing portion 11b performs reading of the discriminating information 85 from the memory 12. Then in step S320 execution of the general-purpose control program 82 is started. In step S330 judgment whether the process that is executed in the general-purpose control program 82 is a process which relates to the unconnected device, is performed based on the discriminating information 85.

In case where it is judged that the process is not a process which relates to the unconnected device in step S150, the program executing portion 11b executes the normal process, that is, a program module for the process in step S340. To the contrary, in case where it is judged that the process is a process which relates to the unconnected device, the program executing portion 11b judges that the unconnected device is not exist, and the process is skipped in step S341.

Then in step S350 the program executing portion 11b performs judgment whether execution of all the control programs which relate to the commanded control is completed or not. In case where it is not completed, the process moves again to step S330. In case where it is completed, the process is terminated.

### Third Embodiment

### 3-1. About Internal Configuration>

Explanation will be omitted because it is quite the same as the first embodiment.

### 3-2. About Maximum Configuration of Device Portion

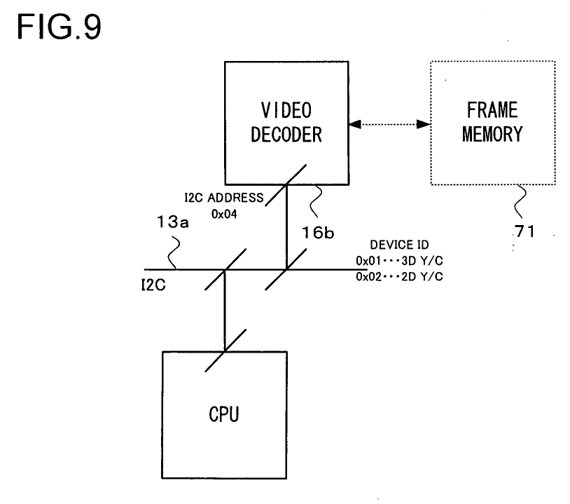

Hereinafter, a maximum configuration of the device portion which can be connected to the communication bus 13 that is included in the television apparatus 1 according to a third embodiment of the present invention will be explained with reference to the block diagrams in FIG. 3 and FIG. 9.

As shown in FIG. 3, the maximum configuration of the I2C bus 13a and the PCI bus 13b according to the present embodiment is quite the same as that of the first embodiment. However, as shown in FIG. 9, two kinds of video decoders such as a video decoder 16b that is 2D Y/C model and a video decoder 16b that is 3D Y/C model can be connected to the bus as the video decoder 16b which is connected to the address 0x04 of the I2C bus 13a. This is realized by same type of connection pin arrangement of these two kind models.

However, these two video decoders 16b have different device IDs respectively. For example, in the example shown in FIG. 9, it is defined in advance that the device ID of the 3D Y/C model is 0x01 and the device ID of the 2D Y/C model is 0x02. It is possible for the device detecting portion 11a to judge which model of the video decoder 16b is connected by performing confirmation of the device ID when the devices are detected.

### 3-3. About Configuration of Function Portion

Hereinafter configuration of the function portion which is included in the television apparatus 1 according to the third embodiment of the present invention will be explained with reference to the functional block diagram of FIG. 1. It should be noted that the portions which are the same as those in the first embodiment are given the same reference numerals and further explanation about them will be omitted.

As shown in FIG. 1 the configuration itself of the function portion according to the present embodiment is quite the same as that of the first embodiment. However, a part of function of the device detecting portion 11a is different. The device detecting portion 11a according to the present embodiment not only sends the detection signal to each of the connecting portions and the connecting slots of the communication bus 13 but also it obtains the device ID of the device portion which is connected to each of the connecting portions. Then, the device detecting portion 11a identifies kind of the device portion which is connected by referring to the device ID information 84. According to this arrangement, it is possible to identify kind of the device portion by the device ID even when a plurality of kinds of the device portions can be connected to an identical address.

Further, it is possible for the device detecting portion 11a to judge kind of the device portion by directing execution of a prescribed process to the respective device portions on trial. For example, assuming that it is possible to connect a plurality of models of the video decoders 16b to the I2C address 0x04 as shown in FIG. 9. In such case, the video decoder 16b is checked whether a frame memory 71 is loaded in the video decoder 16b.

To be more concrete, a process which is necessary to access to the frame memory 71 is executed on trial. In case where an error is returned to it, it is judged that the video decoder 16b is the 2D Y/C model on which the frame memory 71 is not loaded. To the contrary, in case where a normal reply is returned, it is judged that the video decoder 16b is the 3D Y/C model on which the frame memory 71 is loaded. According to this trial, it is possible to identify kinds of the plurality of device portions without referring to the device ID information 84.

### 3-4. About Execution Process of General-purpose Control Program

Explanation will be omitted because it is quite the same as the first embodiment.

### Other Embodiments

As above described, the present invention is explained by way of preferable embodiments and examples, however, the present invention is not limited to the above described embodiments, and the present invention can be carried out with various modifications within the scope and spirit of the present invention.

As a result, the present invention can be applied to the below described embodiments.

(A) The external connecting terminal and the demodulator are taken as examples of the devices to be connected to the communication bus 13 to explain the above described embodiments, detection may be performed for device other than these examples and process is branched when the general-purpose control program 82 is executed. For example, detection may be performed for an information recording device such as a hard disk, an optical disc drive or the like, or for a communication device such as wireless LAN or the like.
(B) In the above described embodiments, though various kinds of function portions which relate to the device detecting process and the execution process of the general-purpose control program, are realized by executing program on processing unit such as micro processor and the like, the various kinds of function portions may be realized by a plurality of circuits.
(C) Though a configuration in which the control portion 11 and respective function portions for volume control are equipped inside of the television apparatus 1 is taken as an example to explain the above described embodiments, a part or all of the configuration may be realized by the external devices which are connected via a network. For example, the kind information 81 and the general-purpose control program 82 which are stored in the ROM 14 may be stored in an information processing device that exists on a network (for example, network server, or the like), and the kind information 81 and the general-purpose control program 82 may be referred by a plurality of image processing apparatuses. According to this arrangement, it is possible to perform updating of various kinds of information collectively.

What is claimed is:

1. An image processing apparatus, comprising:
a control portion;
a storing portion;
a plurality of device portions which can be controlled by the control portion;
a communication bus which connects the control portion and the device portions; and
a device detecting portion which performs detection of the device portions which are connected to the communication bus, wherein
the storing portion stores kind information which shows kind of all the device portions that can be connected to the communication bus, and general-purpose control program which is utilized by the control portion to perform control of the device portions,
when the general-purpose control program is executed by the control portion,
detection is performed by the device detecting portion,
discrimination is performed between the kind of the device portions which are connected to the communication bus and the kind of the device portions which are not connected to the communication bus based on the detection result and the kind information, and
the general-purpose control program is executed such that the device portions which are not connected to the communication bus are not an object to be controlled.

2. The image processing apparatus according to claim 1, further comprising
a discriminating information obtaining portion which stores discriminating information that shows result of the discrimination in the storing portion when power of the image processing apparatus is turned on, wherein
when the general-purpose control program is executed by the control portion, the discriminating information is read out from the storing portion, then the execution of the general-purpose control program is performed.

3. The image processing apparatus according to claim 2, wherein
the storing portion stores first related information which correlates an address of a connecting portion that connects the communication bus and the device portions with the kinds of the device portions that are connected corresponding to the address,
the device detecting portion sends a prescribed signal to the connecting portion, and
the detection of the device portions which are connected to the communication bus is performed based on the address of the connecting portion from which reply is returned and the first related information.

4. The image processing apparatus according to claim 2, wherein
the storing portion stores second related information which correlates a device ID of a connecting slot that connects the communication bus and the device portions with the kinds of the device portions that are connected corresponding to the device ID,
the device detecting portion sends a prescribed signal to the connecting slot, and
the detection of the device portions which are connected to communication bus is performed based on the device ID of the connecting slot from which reply is returned and the second related information.

5. The image processing apparatus according to claim 2, wherein
detecting object of the device detecting portion is an external connecting terminal to perform input and output of video signal and audio signal.

6. The image processing apparatus according to claim 2, wherein
detecting object of the device detecting portion is a demodulator to perform demodulation of video signal and audio signal which are input from a tuner.
